(19) United States
(12) Patent Application Publication
(10) Pub. No.: US 2002/0193981 A1
(43) Pub. Date: Dec. 19, 2002

(54) Method of incremental and interactive clustering on high-dimensional data

(75) Inventors: Wing Wai Keung, Sheung Wan (CN); Kwan Po Wong, Sheung Wan (CN); Hong Ki Chu, Sheung Wan (CN)

Correspondence Address: ALIX YALE & RISTAS LLP, 750 MAIN STREET, SUITE 1400, HARTFORD, CT, 06103, US

(73) Assignee: Lifewood Interactive Limited

(21) Appl. No.: 09/810,976

(22) Filed: Mar. 16, 2001

(51) Int. Cl. G06F 17/20

(52) U.S. Cl. 704/1

(57) ABSTRACT

In a method for clustering high-dimensional data, the high-dimensional data is collected in two hierarchical data structures. The first data structure, called O-Tree, stores the data in data sets designed for representing clustering information. The second data structure, called R-Tree, is designed for indexing the data set in reduced dimensionality. R-Tree is a variant of O-Tree, where the dimensionality of O-Tree is reduced using singular value decomposition to produce R-Tree. The user specifies requirements for the clustering, and clusters of the high-dimensional data are selected from the two hierarchical data structures in accordance with the specified user requirements.

### BACKGROUND OF THE INVENTION

The present invention relates to the field of computing. More particularly the present invention relates to a new methodology for discovering cluster patterns in high-dimensional data.

Data mining is the process of finding interesting patterns in data. One such data mining process is clustering, which groups similar data points in a data set. There are many practical applications of clustering such as customer classification and market segmentation. The data set for clustering often contains a large number of attributes. However, many of the attributes are redundant and irrelevant to the purposes of discovering interesting patterns.

Dimension reduction is one way to filter out the irrelevant attributes in a data set to optimize clustering. With dimension reduction, it is possible to obtain improvement in orders of magnitude. The only concern is a reduction of accuracy due to elimination of dimensions. For large database systems, a global methodology should be adopted since it is the only dimension reduction technique which can accommodate all data points in the data set. Using a global methodology requires gathering all data points in the data set prior to dimension reduction. Consequently, conventional global dimension reduction methodologies can not be utilized as incremental systems.

Conventional clustering algorithms, such as k-mean and CLARANS, are mainly based on a randomized search. Hierarchical search methodologies have been proposed to replace the randomized search methodology. Examples include BIRCH and CURE, which uses a hierarchical structure, k-d tree, to facilitate clustering large sets of data. These new algorithms improve I/O complexity. However, all of these algorithms only work on a snapshot of the database and therefore are not suitable as incremental systems.

### SUMMARY OF THE INVENTION

Briefly stated, the invention in a preferred form is a method for clustering high-dimensional data which includes the steps of collecting the high-dimensional data in two hierarchical data structures, specifying user requirements for the clustering, and selecting clusters of the high-dimensional data from the two hierarchical data structures in accordance with the specified user requirements.

The hierarchical data structures which are employed comprise a first data structure called O-Tree, which stores the data in data sets specifically designed for representing clustering information, and a second data structure called R-Tree, specifically designed for indexing the data set in reduced dimensionality. R-Tree is a variant of O-Tree, where the dimensionality of O-Tree is reduced to produce R-Tree. The dimensionality of O-Tree is reduced using singular value decomposition, including projecting the full dimension onto subspace which minimize the square error.

Preferably, the data fields of the clustering information include a unique identifier of the cluster, a statistical measure equivalent to average of the data points in the cluster, the total number of data points that fall within the cluster, a statistical measure of the minimum value of the data points in each dimension, a statistical measure of the maximum value of the data points in each dimension, the ID of the node that is the direct ancestor of the node, and an array of IDs of the sub-clusters within the cluster. There are no limitations on the minimum number of child nodes of an internal node.

It is an object of the invention to provide a new methodology for clustering high-dimensional databases in an incremental and interactive manner.

It is also an object of the invention to provide a new data structure for represent the clustering pattern in the data set.

It is another object of the invention to provide an effective computation and measurement of the dimension reduction transformation matrix.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which: FIG. 1 is functional diagram of the subject clustering method;

FIGS. 2a and 2b are a flow diagram of the new data insertion routine of the subject clustering method; and

FIG. 3 is a flow diagram of the node merging routine of the subject clustering method.

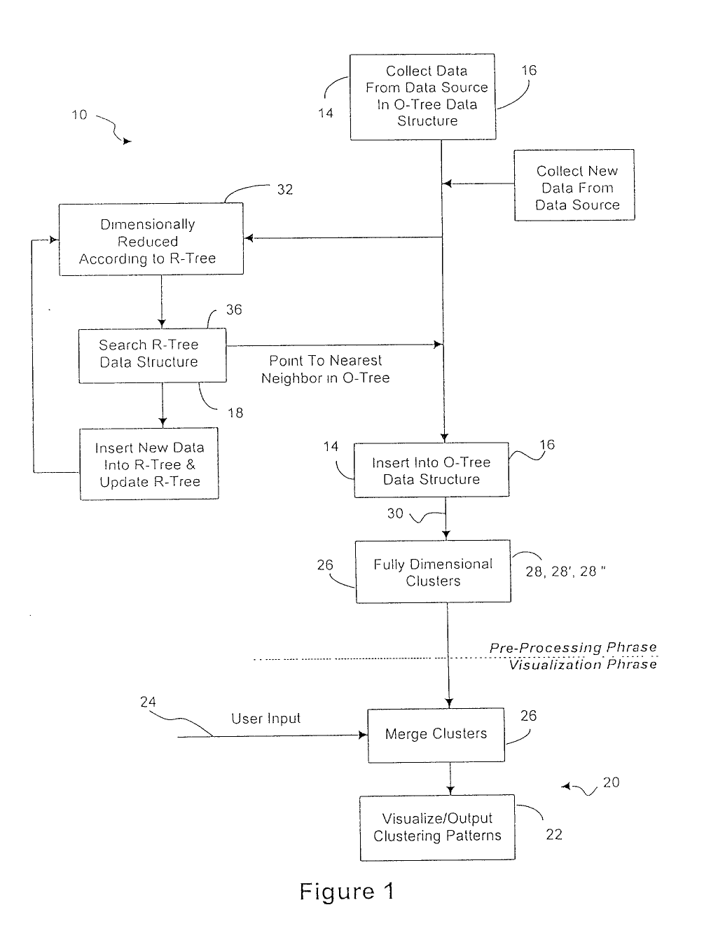

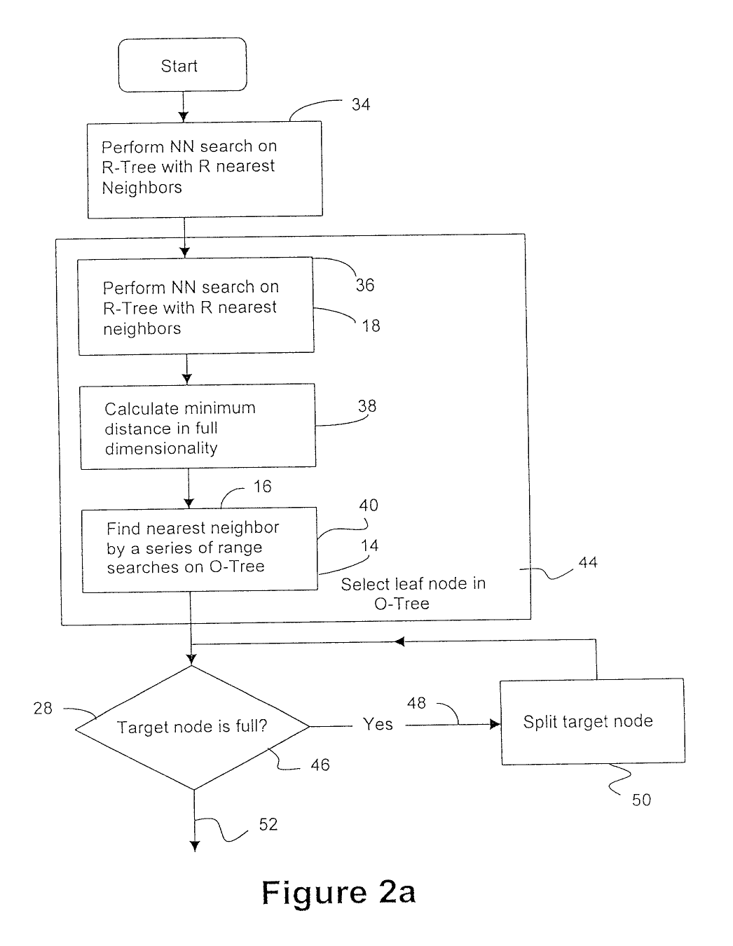

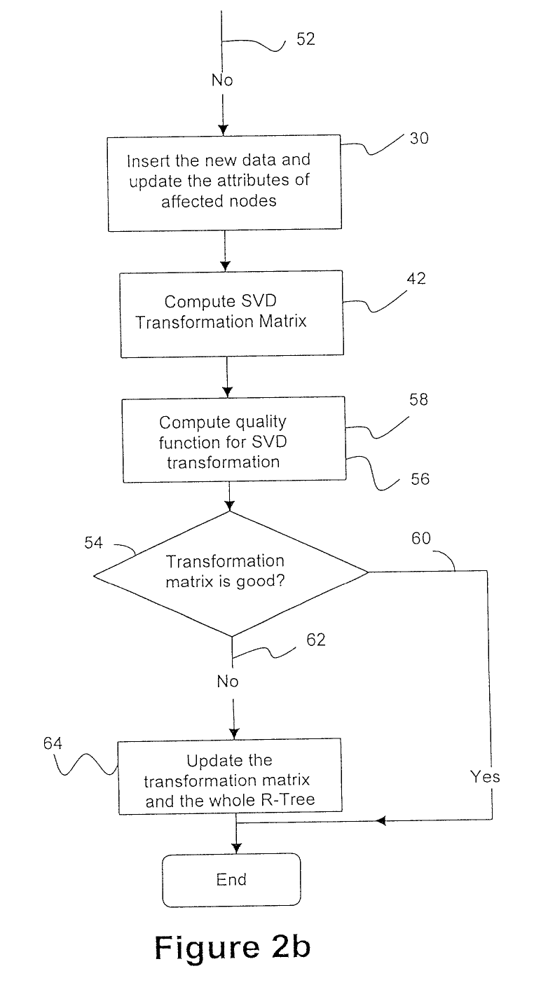

### DETAILED DESCRIPTION OF THE PREFERRED EMBODIMENT

Clustering analysis is the process of classifying data objects into several subsets. Assuming that set X contains n objects (X={x₁, x₂, x_{3,} . . . , xₙ}), a clustering, C, of set X separates X into k subsets ({C₁, C₂, C₃, . . . , Cₖ}) where each of the subsets {C₁, C₂, C₃, . . . , Cₖ} is a non-empty subset, each object n is assigned to a subset, and each clustering satisfies the following conditions:

|C_{I}|>0, for all i; 1.

$${{⋃}^{k}}_{i = 1} {C}_{i} := X ;$$

C_{I}∩C_{J}=φ, for i≠j 3.

Most of the conventional clustering techniques suffer from a lack of user interaction. Usually, the user merely inputs a limited number of parameters, such as the sample size and the number of clusters, into a computer program which performs the clustering process. However, the clustering process is highly dependent on the quality of data. For example, different data may require different thresholds in order to provide good clustering results. It is impossible for the user to know the optimum value of the input parameters in advance without conducting the clustering process one or more times or without visually examining the data distribution. If the thresholds are wrongly set, the clustering process has to be restarted from the very beginning.

Moreover, all the conventional clustering algorithms operate on a snapshot of the database. If the database is updated, the clustering algorithm has to be restarted from the beginning. Therefore, conventional clustering algorithms cannot be effectively utilized for real-time databases.

The present method of clustering data solves the above-described problem in an incremental and interactive two phase approach. In the first, pre-processing phase 12, a data structure 14 containing the data set 16 and an efficient index structure 18 of the data set 16 are constructed in an incremental manner. The second, visualization phase 20, supports both interactive browsing 22 of the data set 16 and interactive formulation 24 of the clustering 26 discovered in the first phase 12. Once the pre-processing phase 12 has finished, it is not necessary to restart the first phase if the user changes any of the parameters, such as the total number of clusters 26 to be found.

The subject invention utilizes a hierarchical data structure 14 called O-Tree, which is specially designed to represent clustering information among the data set 16. O-Tree data structure 14 provides a fast and efficient pruning mechanism so that the insertion, update, and selection of O-Tree nodes 28 can be optimized for peak performance. The O-Tree hierarchical data structure 14 provides an incremental algorithm. Data may be inserted 30 and/or updated making use of the previous computed result. Only the affected data requires re-computation instead of the whole data set, greatly reducing the computation time required for daily operations.

The O-Tree data structure 14 is designed to describe the clustering pattern of the data 16 set so it need not be a balanced tree (i.e. the leaf nodes 28 are not required to lie in the same level) and there is no limitation on the minimum number of child nodes 28′ that an internal node 28 should have. For the structure of an O-Tree node 28, each node 28 can represent a cluster 26 containing a number of data points. Preferably, each node 28 contains the following information: 1) ID—a unique identifier of the node 28; 2) Mean—a statistical measure which is equivalent to the average of the data points in the cluster; 3) Size—the number of data points that fall into the cluster 26; 4) Min.—a statistical measure which is the minimum value of the data points in each dimension; 5) Max.—a statistical measure which is the minimum value of the data points in each dimension; 6) Parent—the ID of the node 28″ that is the direct ancestor of this node 28; 7) Child—an array of IDs that are the IDs of sub-nodes 28′ within this cluster 26. All the information contained in a node 28 can be re-calculated from its children 28′. Therefore, any changes in a node 28 can directly propagate to the root of the tree in an efficient manner.

It is well known that searching performance in databases decreases as dimensionality increases. This phenomenon is commonly called “dimensionality curse”, and can usually be found among multi-dimensional data structures. To resolve the problem, the technique of dimensionality reduction is commonly employed. The key idea of dimensionality reduction is to filter out some dimensions and at the same time to preserve as much information as possible. If the dimensionality is reduced too greatly, the usefulness of the remaining data may be seriously compromised.

To provide improved searching performance without negatively impacting the database contents, the subject invention utilizes two data structures, an O-Tree data structure 14 having full dimensionality and a R-Tree data structure 18 having a reduced dimensionality. Utilizing the reduced dimensionality of the R-Tree data structure 18 to provide superior searching performance, the clustering operations are performed on the O-Tree data structure 14 to represent the clustering information in full dimensionality.

The dimensionality reduction technique 32 used to construct the R-Tree data structure 18 analyzes the importance of each dimension in the data set 16, allowing unimportant dimensions to be identified for elimination. The reduction technique 32 is applied to high dimension data, such that most of the information in the database converges into a number of dimensions. Since the R-Tree data structure 18 is used only for indexing the O-Tree data structure 14 and for searching, the dimensionality may be reduced significantly beyond the reduction that may be used in conventional clustering software. The subject dimensionality reduction technique utilizes Singular Value Decomposition (SVD) 32. The reason of choosing SVD 32 instead of other, more common techniques is that SVD 32 is a global technique that studies the whole distribution of data points. Moreover, SVD 32 works on the whole data set 16 and provides higher precision when compared with transformation that processes each data point individually.

In a conventional SVD technique, any matrix A (whose number of rows M is greater than or equal to its number of columns N) can be written as the product of an M×N column-orthogonal matrix U, and N×N diagonal matrix W with positive or zero elements (singular values), and the transpose of an N×N orthogonal matrix V. The numeric representation is shown in the following tableau:

$$[ A ] = [ U ] \cdot [ \begin{matrix}{W}_{1} & & & & \\ & {W}_{2} & & & \\ & & ⋯ & & \\ & & & ⋯ & \\ & & & & {W}_{N}\end{matrix} ] \cdot [ {V}^{T} ]$$

However, the calculation of the transformation matrix V can be quite time consuming (and therefore costly) if SVD 32 is applied to a data set 16 of the type which is commonly subjected to clustering. The reason is that the number of data M is extremely large when compared with the other dimensions of the data set 16.

A new algorithm is utilized for computing SVD 32 in the subject invention to achieve a superior performance. Instead of using the matrix A directly, the subject algorithm performs SVD 32 on an alternative form, matrix A^{T}•A. The following illustrates the detailed calculation of the operation:

$$\begin{matrix}{A}^{T} \cdot A = {( U \cdot H \cdot {V}^{T} )}^{T} \cdot ( U \cdot W \cdot {V}^{T} ) \\ = ( {( {V}^{T} )}^{T} \cdot {W}^{T} \cdot {U}^{T} ) \cdot ( U \cdot W \cdot {V}^{T} ) \\ = V \cdot W \cdot {U}^{T} \cdot U \cdot W \cdot {V}^{T} \\ = V \cdot {W}^{2} \cdot {V}^{T}\end{matrix}$$

Note that the SVD 32 of matrix A^{T}•A generates the squares of the singular values of those directly computed from matrix A, and at the same time the, transformation matrix is the same and equal to V for both matrix A and matrix A^{T}•A. Therefore, SVD 32 of matrix A^{T}•A preserves the transformation matrix and keeps the same order of importance of each dimension from the original matrix A. The benefit of utilizing matrix A^{T}•A instead of matrix A is that it minimizes the computation time and the memory usage of the transformation. If the conventional approach is used, the process or SVD 32 will mainly depend on the number of records M in the data set 16. However, if the improved approach is used, the process will depend on the number of dimension N. Since M is much larger than N in a real data set 16, the improved approach will out perform the conventional one. Besides, the memory storage for matrix A is M×N, while the storage of matrix A^{T}•A is only N×N.

The only tradeoff for the improved approach is that matrix A^{T}•A has to be computed for each new record that is inserted into the data set 16. The computational cost of such calculation is O(M×N²). Ordinarily, such a calculation would be quite expensive. However, since the subject method of clustering is an incremental approach, the previous result may be used to minimize this cost. For example, if the matrix A^{T}•A has already been computed and a new record is then inserted into the data set 16, the updated matrix A^{T}•A is calculated directly by:

$$\begin{matrix}{A}_{i + 1}^{T} \cdot {A}_{i + 1} = [ \begin{matrix}{a}_{1 , 1} & {a}_{2 , 1} & & & {a}_{i , 1} & {a}_{i + 1 , 1} \\ {a}_{1 , 2} & {a}_{2 , 2} & ⋯ & & {a}_{i , 2} & {a}_{i + 1 , 2} \\ ⋯ & ⋯ & & ⋯ & ⋯ & ⋯ \\ {a}_{1 , N} & {a}_{2 , N} & & & {a}_{i , N} & {a}_{i + 1 , N}\end{matrix} ] \cdot [ \begin{matrix}{a}_{1 , 1} & {a}_{1 , 2} & & {a}_{1 , N} \\ {a}_{2 , 1} & {a}_{2 , 2} & & {a}_{2 , N} \\ & & ⋯ & \\ & & ⋯ & \\ {a}_{i , 1} & {a}_{i , 2} & ⋯ & {a}_{i , N} \\ {a}_{i + 1 , 1} & {a}_{i + 1 , 2} & ⋯ & {a}_{i + 1 , N}\end{matrix} ] \\ = [ \begin{matrix}{a}_{1 , 1} & {a}_{2 , 1} & & & {a}_{i , 1} \\ {a}_{1 , 2} & {a}_{2 , 2} & ⋯ & & {a}_{i , 2} \\ ⋯ & ⋯ & & ⋯ & ⋯ \\ {a}_{1 , N} & {a}_{2 , N} & & & {a}_{i , N}\end{matrix} ] \cdot [ \begin{matrix}{a}_{1 , 1} & {a}_{1 , 2} & ⋯ & {a}_{1 , N} \\ {a}_{2 , 1} & {a}_{2 , 2} & ⋯ & {a}_{2 , N} \\ & ⋯ & & \\ & & ⋯ & \\ {a}_{i , 1} & {a}_{i , 2} & ⋯ & {a}_{i , N}\end{matrix} ] + [ \begin{matrix}{a}_{i + 1 , 1} \\ {a}_{i + 1 , 2} \\ ⋯ \\ {a}_{i + 1 , N}\end{matrix} ] \cdot ( {a}_{i + 1 , 1 } {a}_{i + 1 , 2} … {a}_{i + 1 , N} ) \\ = {A}_{i}^{T} \cdot {A}_{i} + {a}_{i + 1}^{T} \cdot {a}_{i + 1}\end{matrix}$$

The first term A_{I}^{T}•A, in the above equation is the previous computed result and does not contribute to the cost of computation.

For the second term in the above equation, the cost is O(N²). Therefore computation of the matrix A^{T}•A using the above algorithm can be minimized.

The subject clustering technique allows new data to be inserted into an existing O-Tree data set 16, grouping the new data with the cluster 26 containing its nearest neighbor. A nearest neighbor search (NN-search) 34 looking for R neighbors to the new data point is initiated on the R-Tree data set 36, to make use of the improved searching performance provided by the reduced dimensionality. When the R neighbors have been identified by the search, the full dimensional distance between these R neighbors and the new data point is computed 38. The closest R neighbor to the new data point is the R neighbor having the smallest dimensional distance to the new data point.

Using all of the R neighbors found in the NN-search 34 of the R-Tree data set 36, the algorithm then performs a series of range searches 40 on the O-Tree data structure 14 to independently determine which is the closest neighbor. There are two reasons for performing range searches for all of the R neighbors instead of just the R neighbor having the smallest dimensional distance in the R-Tree data set 36. Since the R-Tree data set 36 is dimension reduced, the closest neighbor found in the R-Tree data structure 18 may not be the closest one in the O-Tree data structure 14. The series of range searches in the O-Tree data structure 14 provide a more accurate determination of the closest neighbor since the O-Tree data structure 14 is full dimensional. Second, the R neighbors can be used as a sample to evaluate the quality of the SVD transformation matrix 42.

After selecting 44 the leaf node 28, the algorithm determines whether the contents of the target node is at MAX_NODE 46. If the target node 28 is full 48, the algorithm splits 50 the target node, as explained below. If the target node 28 is not full 52, the algorithm inserts 30 the new data into the target node 28 and updates the attributes of the target node 28.

Inserting a new data point into the data set may require the SVD transformation matrix 42 and the R-Tree data set 36 to be updated. However, computation of the SVD transformation matrix 42 and updating the R-Tree data set 36 is a time consuming operation. To preclude performing this operation when it is not actually required, the subject algorithm tests 54 the quality of the original matrix to determine its suitability for continued use. The quality test 54 compares the R neighbors found in the NN-search 34 of the R-Tree data set 36 to the new matrix to determine whether the original matrix is a good approximation of the new one. The computation of the quality function 58 comprises three steps: 1) compute the sum of the distance between the R sample points using the original matrix; 2) compute the sum of distance between the sample points using the new matrix; 3) return the positive percentage changes between the two sums computed previously. The quality function measures the effective difference between the new matrix and the current matrix. If the difference is below a predefined threshold 62, the original matrix is sufficiently close to the new matrix to allow continued use. If the difference is above the threshold, the transformation matrix must be updated and every node in the R-Tree must be re-computed 64.

A single O-Tree node 28 can at most contain MAX_NODE children 28′, which is set according to the page size of the disk in order to optimize I/O performance. As noted above, the subject algorithm examines a target node 28 to determine whether it contains MAX_NODE children 28′, which would prohibit the insertion of new data. If the target node 28 is full 48, the algorithm splits 50 the target node 28 into two nodes to provide room to insert the new data. The splitting process parses the children 28′ of the target node 28 into various combinations and selects the combination that minimizes the overlap of the two newly formed nodes. This is very important since the overlapping of nodes will greatly affect the algorithm's ability to select the proper node for the insertion of new data.

Similar to conventional clustering techniques, the subject technique requires user input 24 as to the number of clusters 26 which must be formed. If the number of nodes 28 in the O-Tree data set 16 exceeds the user specified number of clusters 26, the number of nodes 28 must be reduced until the number of nodes 28 equals the number of clusters 26. The subject clustering technique reduces the number of nodes 28 in the O-Tree data set 16 by merging nodes 28.

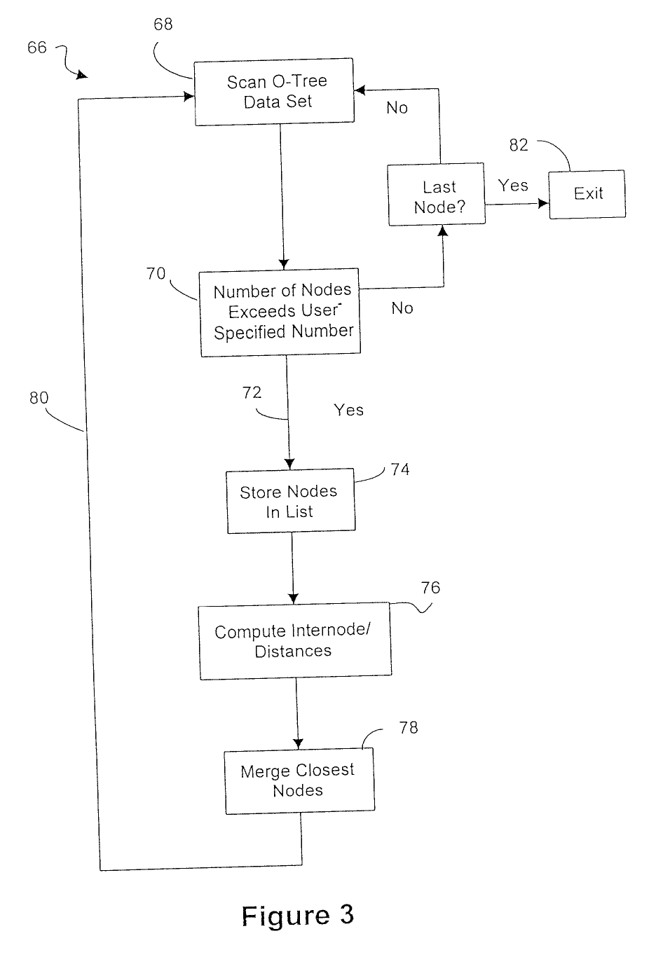

With reference to FIG. 3, the algorithm begins the merging process 66 by scanning 68 the O-Tree data set 16, level by level 70, until the number of nodes 28 in the same level just exceeds the number of clusters 26 which have been specified by the user 72. All of the nodes 28 in the level are then stored in a list 74. Assuming that the number of nodes in the list is K, the inter-nodal distance between every node in the list is computed 76 and stored in a square matrix of K×K. The nodes that have the shortest inter-nodal distance are then merged 78 to form a new node 28. Now the number of nodes 28 in the list is reduced to K−1. This merging process 66 is repeated 80 until the number of nodes 28 is reduced to the number specified by the user 82.

The following is the pseudo-code for node merging:

Input : n = number of clusters user specified
Output : a list of nodes
var node_list : array of O-Tree node
for (each level in O-Tree starting from the root)

begin

count ← number of node in this level
if (count > − n)

begin

for (each node, i, in current level)

begin

add i into node_list

end: /* for */

break

end: /* if */

end: /* if */

dist = a very large number
/* find the closet pair of nodes */
while (size of node_list < n)

begin

for (each node, i, in node_list and j ≠ i)

begin

if (dist > distance (i, j))

begin

node1 − i
node2 − j

end: /* if */

end: /* if */

end: /* if */

remove node1 from node_list
remove node2 from node_list
new_node = mergenode (node1, node2)
add new_node into node_list

end: /* if */

return node_list

It should be appreciated that the subject algorithm is suitable for use on any type of computer, such as a mainframe, minicomputer, or personal computer, or any type of computer configuration, such as a timesharing mainframe, local area network, or stand alone personal computer.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method for clustering high-dimensional data comprising the steps of:
collecting the high-dimensional data in two hierarchical data structures;
specifying user requirements for the clustering; and
selecting clusters of the high-dimensional data from the two hierarchical data structures in accordance with the specified user requirements.

2. The method of claim 1, wherein said hierarchical data structures comprise a first data structure called O-Tree which stores the data in data sets specifically designed for representing clustering information, and a second data structure called R-Tree specifically designed for indexing the data set in reduced dimensionality, R-Tree being a variant of O-Tree.

3. The method of claim 2, wherein the clustering information includes the following fields:
ID, an unique identifier of the cluster;
mean, a statistical measure, which is equivalent to average of the data points in the cluster;
size, the total number of data points that fall within the cluster;
min., a statistical measure, which is the minimum value of the data points in each dimension;
max., a statistical measure, which is the maximum value of the data points in each dimension;
parent, the ID of the node that is the direct ancestor of the node;
child, an array of IDs of the sub-clusters within the cluster.

4. The method of claim 2, further comprising the step of reducing the dimensionality of O-Tree to produce R-Tree.

5. The method of claim 4, wherein the step of reducing the dimensionality of O-Tree comprises the step of performing singular value decomposition including projecting the full dimension onto subspace which minimize the square error.

6. The method of claim 2, wherein there are no limitations on the minimum number of child nodes of an internal node.

7. The method of claim 2, wherein the specified user requirements include the number of clusters to be produced and the step of selecting clusters includes the sub-steps of:
a) traversing the O-Tree level by level until a current level is reached having a number of nodes which is equal to or greater than the user specified number of clusters;
b) constructing a list storing all the nodes in the current level;
c) computing a two dimensional matrix storing the distance between every node in the list;
d) merging the two nodes which are closest to each other among all nodes in the list;
e) reconstructing the list after merging the two closest nodes; and
f) repeating (c) to (e) until the number of nodes in the list is equal to the user specified number of clusters.

8. The method of claim 2 further including the step of incrementally updating the O-Tree to include new data, the step of incrementally updating the O-Tree including the sub-steps of:
a) selecting the leaf node in the O-Tree which is nearest to the new data;
b) evaluating the capacity of leaf node,
i) if the leaf node is not full, insert the new data into the leaf node;
ii) if the leaf node is full, split the leaf node into two new nodes and insert the new data into one of the new nodes;
c) calculating a new transformation matrix for dimensionality reduction;
d) performing a quality test of the original transformation matrix; and
e) updating the transformation matrix and the R-Tree if the original transformation matrix fails the quality test.

9. The method of claim 8, wherein the step of selecting the leaf node includes the following sub-steps:
i) selecting the R nearest neighbors to the new data in reduced dimensionality using the R-Tree;
ii) calculating the minimum distance in full dimensionality between the new data and R nearest neighbors found in step i); and
iii) selecting the nearest neighbor by performing range searches repeatedly on new data with the minimum distance found in full dimensionality using the O-Tree.

10. The method of claim 8, wherein the step of performing a quality test includes the following sub-steps:
i) computing the sum of the distance between a set of sample points using the original transformation matrix;
ii) computing the sum of the distance between a set of sample points using the new transformation matrix; and
iii) calculating a quality measure of the matrix which is equal to the positive percentage difference between the sums computed in steps i) and ii).

11. The method of claim 8, wherein the step of updating of the transformation matrix and the R-Tree includes the following sub-steps:
i) replacing the original transformation matrix with the new transformation matrix;
ii) transforming every leaf node from full dimension to reduced dimension using the new transformation matrix; and
iii) propagating changes until all nodes of the R-Tree are updated.
